(19) United States
(12) Patent Application Publication
(10) Pub. No.: US 2005/0145466 A1
(43) Pub. Date: Jul. 7, 2005

(54) Dial structure

(75) Inventor: Y. C. Wang, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/029,803

(22) Filed: Jan. 5, 2005

(30) Foreign Application Priority Data
Jan. 6, 2004 (TW) TW93200159

(51) Int. Cl. H01H 9/26

(52) U.S. Cl. 200/11 R

(57) ABSTRACT

A dial structure. The dial structure includes a fixing member, a rotating member and a first resilient member. The rotating member is rotatably connected to the fixing member and has an annular contact surface formed with a plurality of contact portions. The first resilient member is connected to the fixing member. The annular contact surface of the rotating member rotatably abuts the first resilient member, such that the contact portions of the annular contact surface sequentially abut the first resilient member to create a positive interval response.

### BACKGROUND OF THE INVENTION

1. Field of the Invention

The present invention relates to a dial structure, and in particular to a dial structure with increased positive interval response.

2. Description of the Related Art

Dials are frequently applied as controls in electronic devices, such as digital cameras. Generally, functional dials requiring minimal operating force provide only minimal positive interval response, and those providing significant positive interval response are operated with corresponding inconvenience.

A conventional dial structure employs a rotating member and a fixed member to create a positive interval response. The fixed member can be formed with a recess or a protrusion, and the rotating member can be formed with corresponding protrusions or recesses, providing positive interval response in certain positions.

In FIG. 1A, a conventional dial structure 1 includes a rotating member 10, a contact member 20, a spring 30 and a fixed portion 40. A plurality of recesses 11 are formed on the circumference of the rotating member 10. The rotating member 10 can rotate clockwise or counterclockwise. The contact member 20 is formed with a protrusion 21 sliding along the circumference of the rotating member 10 and in the recesses 11. The spring 30, between the contact member 20 and the fixed portion 40, exerts pressure.

As shown in FIG. 1A, when the rotating member 10 rotates, resistance between the protrusion 21 and the recess 11 must be overcome. The protrusion 21 can then slide along the circumference of the rotating member 10, as shown in FIG. 1B. A recess 11 aligns with the protrusion 21 which immediately engages the recess 11 via pressure provided by the spring 30, such that, when the rotating member 10 is rotated continuously, a positive interval response is provided.

The dial structure 1, however, has many drawbacks. Resistance between the protrusion 21 and the recess 11 must be overcome, requiring sometimes excessive manual force. Moreover, the protrusion 21 can jam at the circumference of the rotating member 10, causing operating error. Additionally, overcoming the resistance between the protrusion 21 and the recess 11 may rotate the rotating member 10 excessively.

### SUMMARY OF THE INVENTION

Accordingly, an object of the invention is to provide an improved dial structure to overcome the aforementioned problems. The present dial structure requires only small operation force while providing significant positive interval response and automatic positioning. The dial structure comprises a fixing member, a rotating member and a first resilient member. The rotating member is rotatably connected to the fixing member and has an annular contact surface formed with a plurality of contact portions. The first resilient member is connected to the fixing member. The annular contact surface of the rotating member rotatably abuts the first resilient member, such that the contact s portions of the annular contact surface sequentially abut the first resilient member to create a positive interval response.

The contact portions are formed equidistantly on the annular contact surface.

The first resilient member further comprises a first resilient arm, rotatably abutting the annular contact surface.

The contact portions of the annular contact surface are teeth.

The first resilient arm further comprises a curved portion, and the teeth rotatably abut the curved portion.

The first resilient member is a torsion spring.

The dial structure further comprises a dial body connected to the rotating member.

The fixing member further comprises a through hole, through which the dial body is connected to the rotating member.

The first resilient member is closed and annular.

The dial structure further comprises a plurality of positioning portions disposed on the fixing member to position the first resilient member.

The dial structure further comprises a second resilient member connected to the fixing member and opposite the first resilient member. The annular contact surface of the rotating member is located between the first and second resilient members and rotatably abuts the first and second resilient members such that the contact portions of the annular contact surface sequentially and simultaneously abut the first and second resilient members to create a positive interval response.

The first resilient member further comprises a first resilient arm and the second resilient member further comprises a second resilient arm. The annular contact surface rotatably abuts the first and second resilient arms.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view showing operation of a conventional dial structure;

FIG. 1B is another schematic view showing operation of the conventional dial structure;

FIG. 2A is a perspective assembly view of the dial structure of the invention;

FIG. 2B is a perspective exploded view of the dial structure of the invention;

FIG. 3A is a partial assembly view of the dial structure of a first embodiment of the invention;

FIG. 3B is a schematic view showing operation of the dial structure according to FIG. 3A;

FIG. 3C is a schematic view showing operation of the dial structure according to FIG. 3B;

FIG. 3D is a schematic view showing operation of the dial structure according to FIG. 3C;

FIG. 3E is a schematic view showing operation of the dial structure according to FIG. 3D;

FIG. 4 is a partial assembly view of the dial structure of a second embodiment of the invention;

FIG. 5 is a partial assembly view of the dial structure of a third embodiment of the invention;

FIG. 6 is a partial assembly view of the dial structure of a fourth embodiment of the invention; and

FIG. 7 is a partial assembly view of the dial structure of a fifth embodiment of the invention.

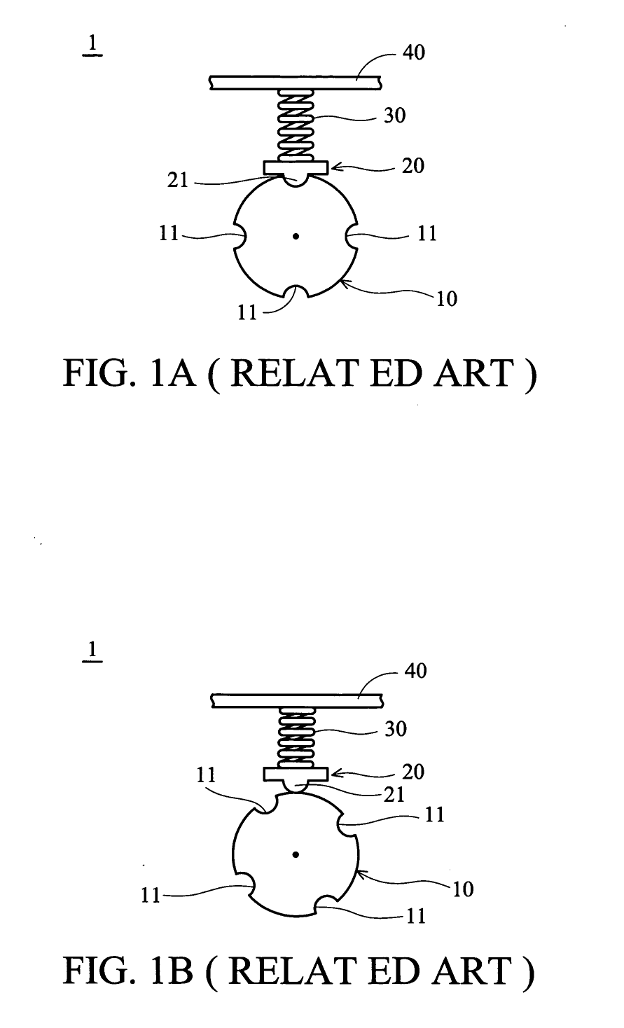

### DETAILED DESCRIPTION OF THE INVENTION

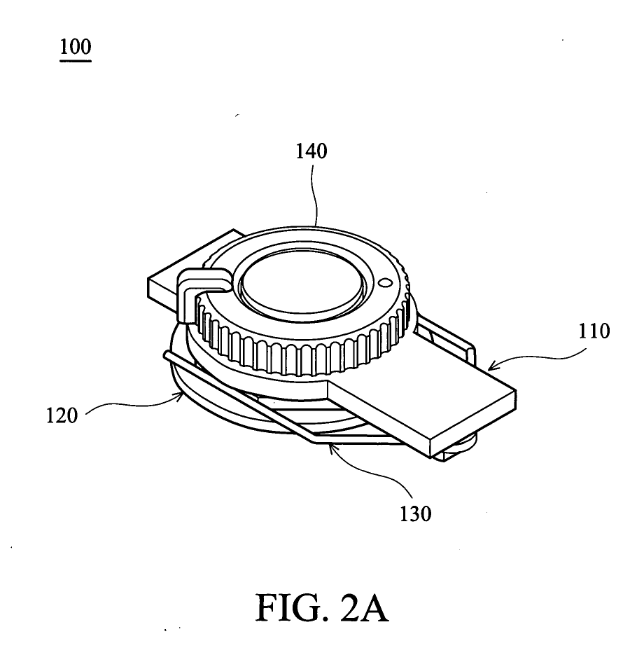

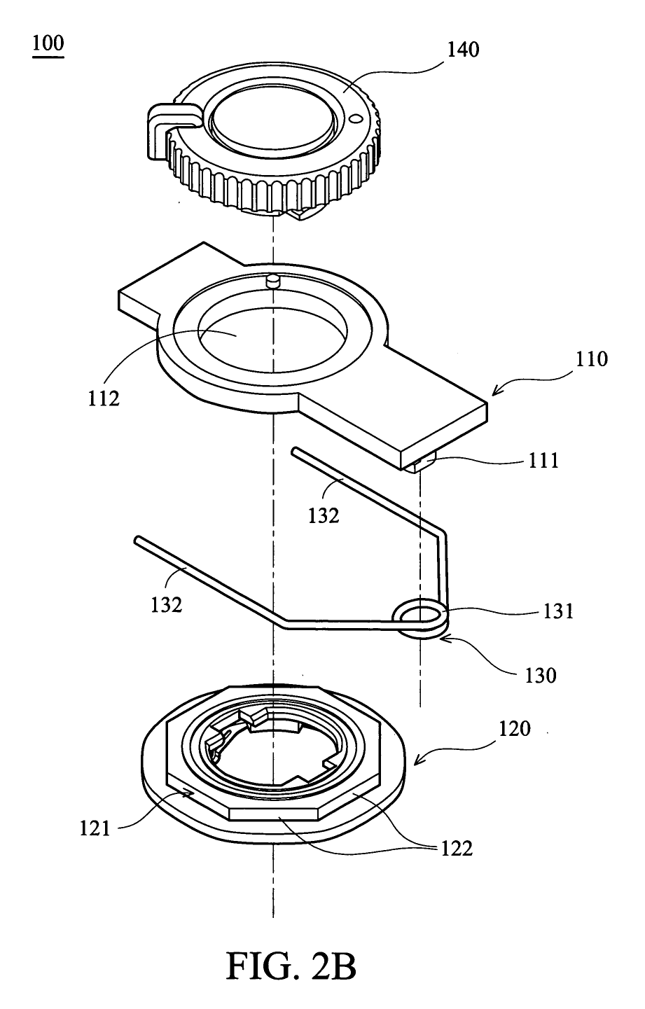

Referring to FIG. 2A and FIG. 2B, the dial structure 100 of the invention comprises a fixing member 110, a rotating member 120, a first resilient member 130 and a dial body 140.

The fixing member 110 has a first connecting portion 111 and a through hole 112. The rotating member 120 is rotatably connected to the fixing member 110 and has an annular contact surface 121. The fixing member 110 can be part of the housing of a digital camera.

The first resilient member 130 is connected to the fixing member 110. Specifically, the first resilient member 130 has a second connecting portion 131 to which the first connecting portion 111 of the fixing member 110 is connected. The first resilient member 130 may be a torsion spring with at least one first resilient arm 132. The annular contact surface 121 of the rotating member 120 rotatably abuts the first resilient arm 132.

The dial body 140 is connected to the rotating member 120 via the through hole 112 of the fixing member 110. Accordingly, the dial body 140 and rotating member 120 are disposed on opposite sides of the fixing member 110, respectively. When the dial body 140 is rotated, the rotating member 120 is rotated commensurately.

When the rotating member 120 is rotated, the annular contact surface 121 thereof abuts the first resilient arm 132 of the first resilient member 130, causing change in resilience of the first resilient member 130, thereby creating a positive interval response. Accordingly, the design point of the dial structure 100 depends on correspondence between the contact surface 121 of the rotating member 120 and the first resilient member 130.

In the following embodiments, the fixing member 110 and dial body 140 are omitted for simplification of description.

First Embodiment

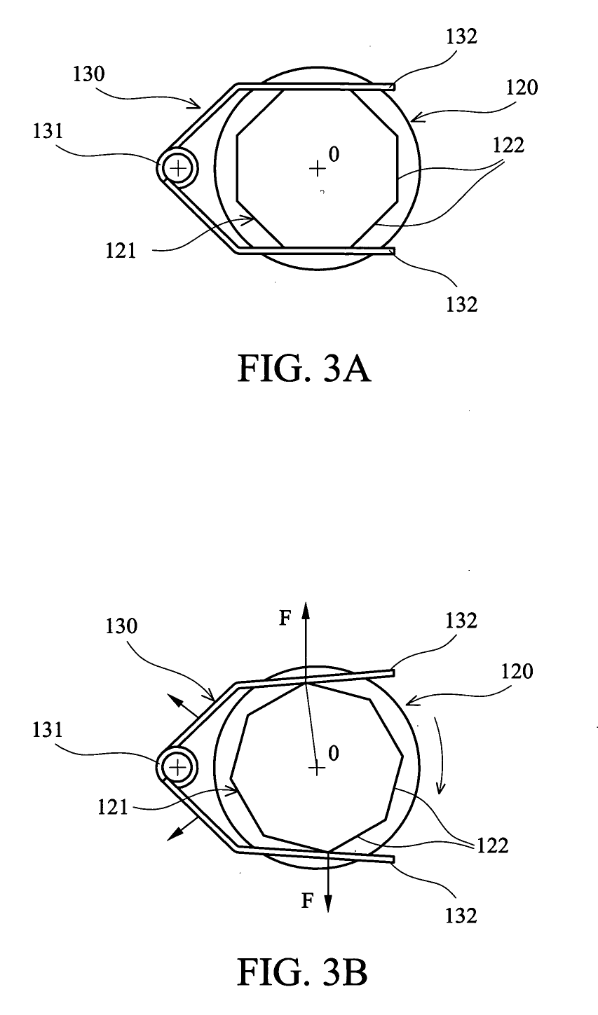

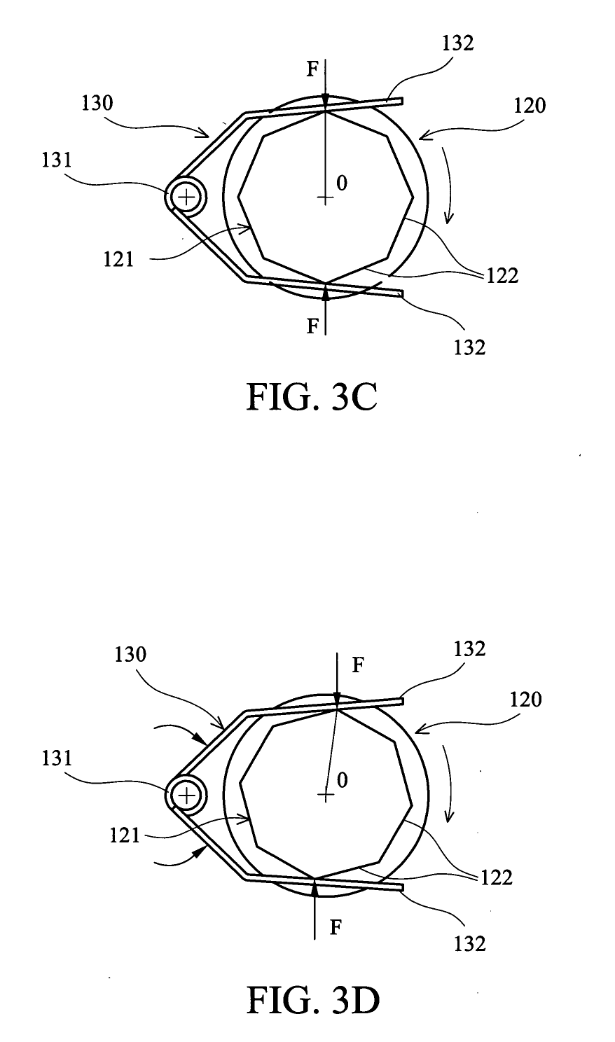

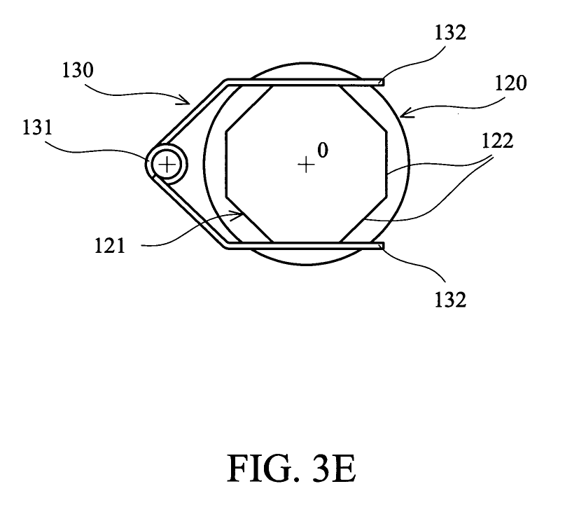

Referring to FIG. 3A, the annular contact surface 121 of the rotating member 120 is formed with a plurality of equidistant contact portions 122. Namely, the contact portions 122 form a regular polygonal annular contact surface 121. In this embodiment, the annular contact surface 121 is octagonal. In an initial condition, two first resilient arms 132 of the first resilient member 130 abut opposite contact portions 122 of the annular contact surface 121, respectively. At this point, the first resilient arms 132 provide predetermined resilience.

When the rotating member 120 rotates clockwise by a small angle, the first resilient arms 132 of the first resilient member 130 are spread by the annular contact surface 121 (contact portions 122), as shown in FIG. 3B. At this point, the annular contact surface 121 exerts a force F on each first resilient arm 132, thereby creating torque thereon. When the rotating member 120 continues to rotate clockwise, the distance between the exertion point at which the annular contact surface 121 abuts each first resilient arm 132 and the center ◯ of the rotating member 120 reduces gradually. Thus, the torque created between the annular contact surface 121 and each first resilient arm 132 reduces gradually. When the annular contact surface 121 rotates to another condition as shown in FIG. 3C, no torque exists between the annular contact surface 121 and each first resilient arm 132 and the resilience accumulated in each first resilient arm 132 is maximized. At this point, the annular contact surface 121 and first resilient arms 132 are temporarily stable. When the rotating member 120 continues to rotate clockwise, the first resilient arms 132 oppress the annular contact surface 121 by resilience thereof, causing the annular contact surface 121 to quickly rotate to the positions shown in FIGS. 3D and 3E. At this point, the rotating member 120 has completed rotation of an interval (a mode). Accordingly, after the rotating member 120 is rotated over a predetermined angle, the rotating member 120 can automatically complete rotation without extra force. Further, when the rotating member 120 repeats the rotation of FIG. 3A to FIG. 3E, a positive interval response is thereby created.

Second Embodiment

In this embodiment, elements corresponding to those in the first embodiment are given the same reference numerals.

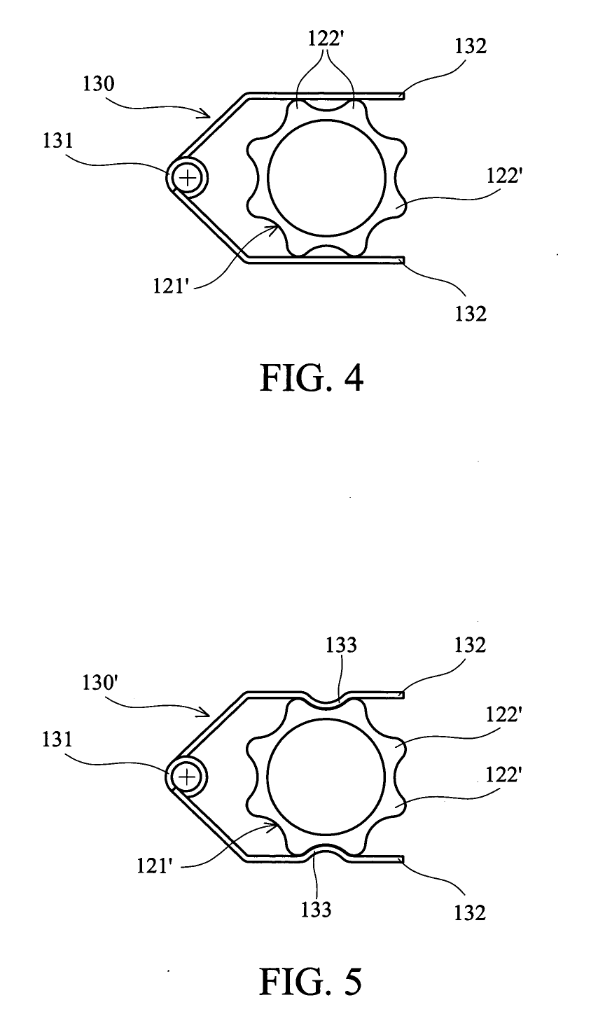

Referring to FIG. 4, the annular contact surface 121′ of the rotating member 120 is formed with a plurality of equidistant teeth 122′. Namely, the contact portions 122 in the first embodiment are replaced by the teeth 122′. Specifically, the annular contact surface 121′ is formed with eight equidistant teeth 122′.

As shown in FIG. 4, in an initial condition, each first resilient arm 132 of the first resilient member 130 abuts the tops of two adjacent teeth 122′. At this point, each first resilient arm 132 provides predetermined resilience.

When the rotating member 120 (annular contact surface 121′) rotates, the first resilient arms 132 of the first resilient member 130 are spread by the tops of the teeth 122′. At this point, the top of each tooth 122′ exerts a force on each first resilient arm 132.

When the rotating member 120 continues to rotate, the force the annular contact surface 121′ exerts on each first resilient arm 132 increases gradually. When each first resilient arm 132 is vertically abutted by the top of one tooth 122′, the resilience accumulated in each first resilient arm 132 is maximized. At this point, the annular contact surface 121′ and first resilient arms 132 are temporarily stable. When the rotating member 120 continues to slightly rotate, the first resilient arms 132 oppress the annular contact surface 121′ (teeth 122′) by the resilience thereof, causing the annular contact surface 121′ to quickly rotate in the direction. When each first resilient arm 132 abuts the tops of two adjacent teeth 122′ again, as shown in FIG. 4, the rotating member 120 has completed an interval. Accordingly, after the rotating member 120 is rotated beyond a predetermined angle, the rotating member 120 can automatically complete rotation without extra exertion. Similarly, when the rotating member 120 (annular contact surface 121′) repeats the aforementioned rotation, a positive interval response is provided.

Third Embodiment

In this embodiment, elements corresponding to those in the first and second embodiments are given the same reference numerals.

Referring to FIG. 5, the first resilient member of this embodiment is different from that of the second embodiment. Specifically, each first resilient arm 132 of the first resilient member 130′ has a curved portion 133. In an initial condition, the curved portion 133 of each first resilient arm 132 abuts the recess between two adjacent teeth 122′. At this point, each first resilient arm 132 provides predetermined resilience. Other elements in this embodiment are the same as those in the first and second embodiments, and explanation thereof will be omitted for simplification of the description.

When the rotating member 120 (annular contact surface 121′) rotates, the curved portions 133 of the first resilient arms 132 are spread by the tops of the teeth 122′. At this point, the top of each tooth 122′ exerts a force on each first resilient arm 132. When the rotating member 120 continues to rotate, the force the annular contact surface 121′ exerts on each first resilient arm 132 increases gradually. When the curved portion 133 of each first resilient arm 132 is vertically abutted by the top of one tooth 122′, the resilience accumulated in each first resilient arm 132 is maximized. At this point, the annular contact surface 121′ and first resilient arms 132 are temporarily stable. When the rotating member 120 continues to rotate, the first resilient arms 132 oppress the annular contact surface 121′ (teeth 122′) by the resilience thereof, causing the annular contact surface 121′ to quickly rotate. When the curved portion 133 of each first resilient arm 132 abuts the recess between two adjacent teeth 122′ again, as shown in FIG. 5, the rotating member 120 has completed an interval. Accordingly, after the rotating member 120 is rotated beyond a predetermined angle, the rotating member 120 can automatically complete rotation without extra exertion. Similarly, when the rotating member 120 (annular contact surface 121′) rotates continuously, a positive interval response is provided.

Specifically, the curved portions 133 of the first resilient member 130′ can increase the resilience thereof, such that the rotating member 120 can automatically complete the rotation with ease.

Fourth embodiment

In this embodiment, elements corresponding to those in the first embodiment are given the same reference numerals.

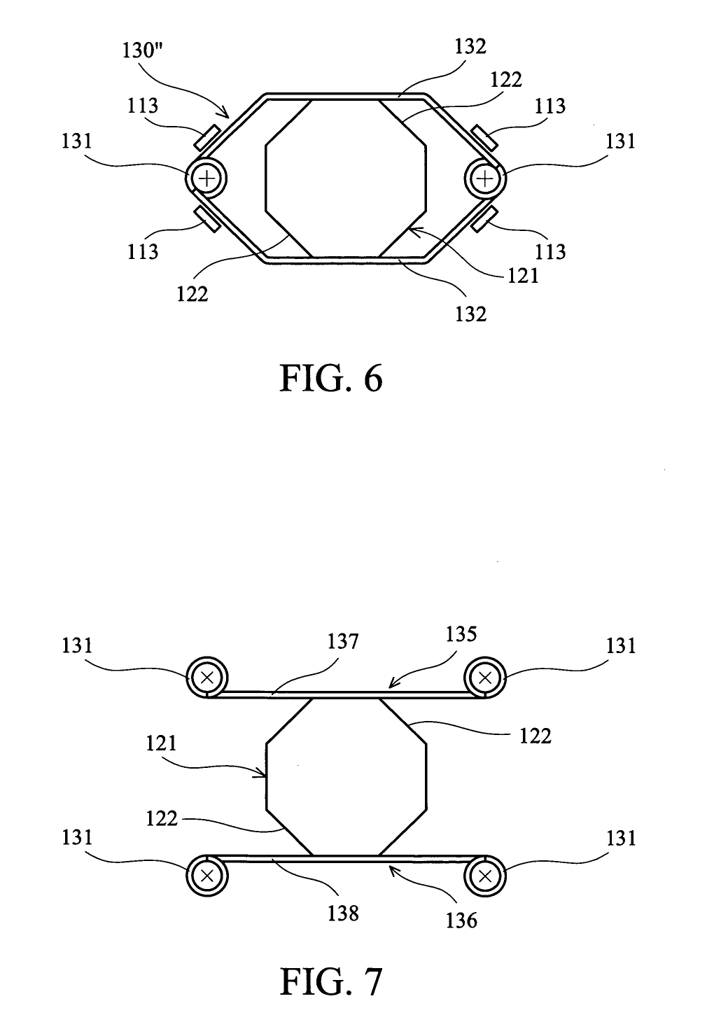

Referring to FIG. 6, the first resilient member 130″ of this embodiment differs from that of the second embodiment in that it is closed and annular, and the fixing member 110 has four positioning portions 113 disposed thereon. The positioning portions 113 are disposed on the outside of the first resilient member 130″ to position or fix the first resilient member 130″. In an initial condition, two first resilient arms 132 of the first resilient member 130″ abut two opposite contact portions 122 of the annular contact surface 121, respectively. Creation of positive interval response between the rotating member 120 (annular contact surface 121) and the first resilient member 130″ is the same as that of the first embodiment, and explanation thereof is omitted for simplification of description.

Specifically, the closed first resilient member 130″ of this embodiment can also increase the resilience thereof.

Fifth Embodiment

In this embodiment, elements corresponding to those in the first embodiment are given the same reference numerals.

Referring to FIG. 6, this embodiment differs from the second embodiment in that the dial structure of this embodiment comprises a first resilient member 135 and a second resilient member 136 opposite thereto. The first resilient member 135 and second resilient member 136 are connected to the fixing member 110. Additionally, the first resilient member 135 has a first resilient arm 137 and the second resilient member 136 has a second resilient arm 138. As shown in FIG. 7, the annular contact surface 121 of the rotating member 120 is disposed between the first resilient arm 137 and the second resilient arm 138. In an initial condition, the first resilient arm 137 and second resilient arm 138 abut two opposite contact portions 122 of the annular contact surface 121, respectively. Creation of positive interval response among the rotating member 120 (annular contact surface 121), first resilient member 135 and second resilient member 136 is similar to that of the first embodiment, and explanation thereof is omitted for simplification of description.

Specifically, since this embodiment employs the opposite first resilient member 135 and second resilient member 136 and the first resilient member 135 and second resilient member 136 are respectively connected to the fixing member 110 using two second connecting portions 131, the first resilient member 135 or second resilient member 136 of this embodiment provides greater resilience than the first resilient member 130 of the first embodiment. Thus, the rotating member 120 can automatically complete rotation with ease.

In conclusion, the structure of the constituent members of the dial structure is simplified, such that positive interval response is significant, avoiding operation error or excessive rotation. Rotating beyond a predetermined angle, the dial structure automatically completes rotation (or the dial structure can provide automatic positioning). Thus, the present dial structure is operated with ease.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A dial structure, comprising:
a fixing member;
a rotating member rotatably connected to the fixing member and having an annular contact surface formed with a plurality of contact portions; and
a first resilient member connected to the fixing member, wherein the annular contact surface of the rotating member rotatably abuts the first resilient member, such that the contact portions of the annular contact surface sequentially abut the first resilient member to create a positive interval response.

2. The dial structure as claimed in claim 1, wherein the contact portions are formed equidistantly on the annular contact surface.

3. The dial structure as claimed in claim 1, wherein the first resilient member further comprises a first resilient arm, and the annular contact surface rotatably abuts the first resilient arm.

4. The dial structure as claimed in claim 3, wherein the contact portions of the annular contact surface are teeth.

5. The dial structure as claimed in claim 4, wherein the first resilient arm further comprises a curved portion, and the teeth rotatably abut the curved portion.

6. The dial structure as claimed in claim 1, wherein the first resilient member is a torsion spring.

7. The dial structure as claimed in claim 1, further comprising a dial body connected to the rotating member.

8. The dial structure as claimed in claim 7, wherein the fixing member further comprises a through hole, through which the dial body is connected to the rotating member.

9. The dial structure as claimed in claim 1, wherein the first resilient member is closed and annular.

10. The dial structure as claimed in claim 9, further comprising a plurality of positioning portions disposed on the fixing member to position the first resilient member.

11. The dial structure as claimed in claim 1, further comprising a second resilient member connected to the fixing member and opposite the first resilient member, the annular contact surface of the rotating member located between the first and second resilient members and rotatably abutting the first and second resilient members such that the contact portions of the annular contact surface sequentially and simultaneously abut the first and second resilient members to create a positive interval response.

12. The dial structure as claimed in claim 11, wherein the first resilient member further comprises a first resilient arm and the second resilient member further comprises a second resilient arm, with the annular contact surface rotatably abutting the first and second resilient arms.
